(19) United States
(12) Patent Application Publication
(10) Pub. No.: US 2014/0279227 A1
(43) Pub. Date: Sep. 18, 2014

(54) Connecting Consumers with Service Providers Independent of Consumer Search

(71) Applicant: Roy Schoenberg, Boston, MA (US)

(72) Inventor: Roy Schoenberg, Boston, MA (US)

(21) Appl. No.: 13/796,435

(22) Filed: Mar. 12, 2013

(51) Int. Cl. G06Q 30/06

(52) U.S. Cl. CPC G06Q 30/0613
USPC 705/26.41

(57) ABSTRACT

A computer-implemented method includes receiving an indication of a request to access to a webpage that identifies service providers who are available for consultations; identifying, by one or more computers, in response to the request one or more available service providers; generating, by the one or more computers, a web page that when displayed on a display device, renders: visual representations corresponding to the identified service providers; and selectable portions of the visual representations through which the consumer selects a service provider from the identified service providers; and receiving data indicating the consumer's selection of the service provider; and establishing a communication channel between a device used by the selected service provider and the device used by the consumer.

### BACKGROUND

The present disclosure is directed to presenting consumers with a webpage that includes controls for promoting connections between consumer and service providers, independent of a consumer search for service providers.

Systems have been developed to provide services that connect consumers and their providers over the Internet and the World Wide Web. Some systems use e-mail messaging and web-based forms to increase the level of connectivity between a member of a health plan and his assigned health care provider. The consumer sends an e-mail or goes to a website that generates and sends a message (typically an e-mail or an e-mail type message) to a local provider.

These types of services have been broadly referred to as “e-visits.” While generally viewed as an addition to the spectrum of services that may be desired by consumers, the benefits of such services are not clear. One of the concerns associated with offering additional communication channels, such as e-mail, is that it can result in over consumption of services, rather than provide for better coordination.

Another system is a brokerage type of system as described in my issued U.S. Pat. No. 7,590,550, which is incorporated herein by reference.

### SUMMARY

In one aspect of the present disclosure, a computer-implemented method includes receiving an indication of a request to access to a webpage that identifies service providers who are available for consultations; identifying, by one or more computers, in response to the request one or more available service providers; generating, by the one or more computers, a web page that when displayed on a display device, renders: visual representations corresponding to the identified service providers; and selectable portions of the visual representations through which the consumer selects a service provider from the identified service providers; and receiving data indicating the consumer's selection of the service provider; and establishing a communication channel between a device used by the selected service provider and the device used by the consumer.

Implementations of the disclosure can include one or more of the following features. In some implementations, the method includes identifying, by the one or more computers, one or more available first service providers that are associated with a first practice; and identifying, by the one or more computers, one or more available second service providers that are associated with a second practice. In other implementations, the webpage renders: visual representations corresponding to the one or more identified first service providers and the one or more identified second service providers; and selectable portions through which the consumer selects one of the one or more identified first service providers or one of the one or more identified second service providers.

In still other implementations, the indication of the request from the device used by the consumer of services comprises: receiving a request from the device used by the consumer of services to consult with a service provider having a service provider profile that satisfies at least some attributes in a set of attributes that define a suitable service provider; and the method further comprises: identifying, by the one or more computers, one or more available service providers satisfying at least some of the attributes in the set of attributes. In yet other implementations, the method includes identifying, by the one or more computer systems, at least one service provider as being presently available to engage in a consultation with the consumer. In still other implementations, one or more of the visual representations are juxtaposed to one or more of the selectable portions in the webpage.

In some implementations, the method includes identifying, by the one or more computers, one or more service providers who are presently available for a consultation with the consumer and who are associated with a particular provider practice. In still other implementations, the method includes determining communication modes that are available for the one or more service providers identified; wherein the selectable portions of the webpage visually indicate one or more of the determined communication modes that are available for the one or more service providers identified. In still other implementations, the method includes determining communication modes that are available for the one or more service providers identified, with the selectable portions of the webpage being color-coded according to the determined communication modes that are available for the one or more service providers identified.

In still another aspect of the disclosure, one or more machine-readable media are configured to store instructions that are executable by one or more processing devices to perform operations including receiving an indication of a request to access to a webpage that identifies service providers who are available for consultations; identifying in response to the request one or more available service providers; generating a web page that when displayed on a display device, renders: visual representations corresponding to the identified service providers; and selectable portions of the visual representations through which the consumer selects a service provider from the identified service providers; and receiving data indicating the consumer's selection of the service provider; and establishing a communication channel between a device used by the selected service provider and the device used by the consumer. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: receiving an indication of a request to access to a webpage that identifies service providers who are available for consultations; identifying in response to the request one or more available service providers; generating a web page that when displayed on a display device, renders: visual representations corresponding to the identified service providers; and selectable portions of the visual representations through which the consumer selects a service provider from the identified service providers; and receiving data indicating the consumer's selection of the service provider; and establishing a communication channel between a device used by the selected service provider and the device used by the consumer. Implementations of this aspect of the present disclosure can include one or more of the foregoing features.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF THE FIGURES

FIG. 1 is a diagrammatic view of a system for connecting consumers with service providers.

FIGS. 2 and 3 are screenshots of webpages used in connecting consumers with service providers.

FIGS. 4 and 5 are flow charts of processes useful in understanding the system of FIG. 1.

FIG. 6 is a block diagram of a computer (computer system) showing exemplary components that can be used for the brokerage system and/or client systems.

### DETAILED DESCRIPTION

The system described below provides a brokerage system with an integrated information and communication platform for connecting consumers with service providers. A consumer accesses a web page that is generated by the brokerage system. The web page displays information indicative of service providers that are currently available to engage in a brokered engagement (e.g., a consultation) with the service provider. The web page displays this information in response to the consumer accessing the web page and independent of the consumer searching for currently available service providers. The web page also displays one or more controls for automatically connecting a consumer with a selected service provider. Through the brokerage system, dynamic populations (e.g., consumers and service providers) engage in interactions at times that are convenient for the consumers and the service providers, because the system matches real-time availability of the service providers with consumers' real-time requests to engage with the service providers. Consumers at clients systems are able to interact on-line with a service provider, even when the two parties are geographically separated. This integrated platform is referred to herein as an engagement brokerage service (brokerage).

FIG. 1 shows an example system 100 implementing the brokerage service. The system 100 includes a computerized system or server 110 for making connections between consumers 120, at client systems 122, and service providers 130, at client systems 132 including, e.g., web cams or the like over a network 103, e.g., the Internet or other types of networks. The computerized system 110 operates as a service running on a web server 102.

The computerized system 110 includes an availability or presence tracking module 112 for tracking the availability of the service providers 130. Availability or presence is tracked actively or passively. In an active system, one or more of the service providers 130 provides an indication to the computerized system 110 that the one or more service providers are available to be contacted by consumers 120 and an indication of the mode by which the provider is contacted. In some examples of an active system, the provider's computer, phone, or other terminal device periodically provides an indication of the provider's availability (e.g., available, online, idle, busy) to the system 110 and a mode (e.g., text, voice, video, etc.) by which he can be engaged. In a passive system, the computerized system 110 presumes that the service provider 130 is available by the service provider's actions, including connecting to the computerized system 110 or registering the provider's local phone number with the system. In some examples of a passive system, the system 110 indicates the provider 130 to be available at all times until the provider logs off, except when the provider is actively engaged with a consumer 120.

The computerized system 110 also includes one or more processes such as the tracking module 112 and a scheduling module 116. The system 110 accesses one or more databases 118. The components of the system 110 and the web server 102 may be integrated or distributed in various combinations as is commonly known in the art.

The database 118 includes information regarding providers engaged with the brokerage system 100. A service provider may be associated with a provider practice, which is a group of service providers that are affiliated with each other, for example by being associated with a physical office, by being associated with an online medical practice, and so forth.

The database 118 stores provider information in association with practice information, if any. Provider information is information indicative of a particular service provider, e.g., a name of the service provider, a state in which the service provider is licensed, and so forth. Practice information includes information indicative of a particular provider practice, e.g., a name of a provider practice. Database 118 stores provider information 140, 142, 144, 146, 148, 150, 152, 154, 156 and practice information 158, 160. Database 118 stores provider information 140, 142, 144 in association with practice information 160. Database 118 stores provider information 146, 148, 150 in association with practice information 158. The service providers specified by provider information 152, 154, 156 are unassociated with a provider practice.

Using the system 100, a consumer 120 communicates with a provider 130 that the consumer selects from the chosen set of providers and/or services. The consumer 120 and provider 130 are connected to the computerized system 110 through a website or other interface on the web server 102 using client devices 122 and 132, respectively. Client devices 122 and 132 can be any combination of, e.g., personal digital assistants, land-line telephones, cell phones, computer systems, media-player-type devices, and so forth. The client devices 122 and 132 enable the consumers 120 to input and receive information as well as to communicate via video, audio, and/or text with the providers 130.

One advantage that the brokerage provides is that the brokerage constantly monitors the availability of a provider for an engagement through a reverse provider practice. In order to achieve such a level of availability, the system assimilates the discretionary or fractional availability windows of time offered by individual providers into a continuous availability perception by consumers. Because many of the services offered to consumers are on-demand, consumers have little expectation that the same provider will be constantly available. However, consumers have an expectation that some provider will be available. As discussed in further detail below, the brokerage system supports a large number of available providers and therefore the system provides tools (e.g., navigational components, links and selection boxes) to assist a consumer in selecting an appropriate provider. In an example, the system promotes searching for service providers by generating a webpage with input elements, including, e.g., text boxes, search boxes, dropdown menus, and so forth.

The computerized system 110 provides information and services to the consumers 120 in addition to connecting them with providers 130. The computerized system 110 includes an access control facility 114, which manages and controls whether a given consumer 120 accesses the system 110 and what level or scope of access to the features, functions, and services the system 110 will provide.

The consumer 120 uses the system 100 to find out more information about a topic of interest. The computerized system 110 identifies service providers 130 that are available at any given moment to communicate with a consumer about a particular type of content. The computerized system 110 facilitates communication between the consumer 120 and provider 130, enabling them to communicate, for example, via a data-network-facilitated video or voice communication channel (such as Voice over IP), land and mobile telephone network channels, and instant messaging or chat. The availability of one or more providers 130 is tracked, and at the instant a consumer 120 desires to connect and engage in a consultation with a provider (e.g., via live video and/or audio,) the system 110 determines whether a provider is available. If a particular provider 130 is available, the system 110 assesses the various modes of communication that are available (e.g., based on common modes and modes preferred by the provider) and connects the consumer 120 and the provider 130 through one or more of the common modes of communication.

In addition, the system selects a mode of communication to use based in part on the relative utility of the various modes. The preferred mode for an engagement is for both the consumer 120 and the provider 130 to use web-based consoles, as this allows each of the other modes to be used as needed. For example, consumers and providers launch chat sessions, voice calls, or video chats from within a web-based console. If the provider 130 is not available, the system 110 identifies other available providers 130 that would meet the consumer's needs. The system 110 enables the consumer 120 to send a message to the consumer's chosen provider. The consumer can also have the system 110 contact the consumer in the future when the chosen provider is available.

Providers participating in the brokerage network can have several states of availability over time. States in which the provider are available include on-line, in which the provider is logged-in and can accept new engagements in any mode, on-line (busy), in which the provider is logged-in but is currently occupied in a video or telephonic engagement, and scheduled, in which the provider is offline but is scheduled to be online at a designated time-point and can pre-schedule engagements for it. While not online, the provider can take messages as in offline state. Other states include off-line, in which the provider is not logged in but can take message-based engagements (i.e., asynchronous engagements), out-of-office, in which the provider is not accepting engagements or messages, and standby, in which the provider is offline and can be paged to Online status by the brokerage network if traffic load demands it (in some examples, consumers see this state as offline).

The operating business model for the provider network employs a remuneration scheme for providers that helps assure that the consumers can find providers in designated professional domains in the online mode. For example, selected providers can be remunerated for being in the standby mode to encourage their on-line availability in case of low discretionary availability by other—providers in their professional domain. Standby providers are also called into the on-line state when the percentage of on-line (busy) providers in their professional domain exceeds a certain threshold of all providers currently on-line (busy and standby). In some examples, the transition of providers from standby to online and back to standby (in case of over capacity or idle capacity) is an automated function of the system.

As noted, the system 100 includes access control facilities 114 that control how consumers 120 access the system and to what extent or level the service provided by the system are made available to consumers. The system 100 also stores and provides access to consumer information (e.g., contact information, and preference/profile information to be described later). However, other consumer information would typically be not accessible to the service provider, such as credit rating information, financial information, and credit card information. Similarly, provider information (e.g., biographies, product and service information, and any information the provider wants to make available to consumers) can be made available. The access control facility 114 would prevent unauthorized access to this information.

The brokerage provides compensation for products and services provided. Access to the system 100 is provided on a subscription basis, with consumers paying a fee (either directly or indirectly through another party) to be provided with a particular level of access to the system. In exchange for providing products or services, the service provider receives compensation from the consumer. In one embodiment, the consumer pays the operator, which keeps a portion (e.g., a percentage payment or a flat fee) and pays the remainder to the service provider. In another embodiment, the consumer or the service provider pays a flat fee or percentage of the fee for the engagement to the operator. The operator is paid a flat fee or a percentage of the fee for the engagement transaction. Alternatively, the consumer or the service provider or both pays a fee (a service fee) to the operator for providing the connection. The brokerage allows consumers to engage provider's “on demand” based on provider availability. Engagements can be established in various ways, including the following.

Asynchronous correspondence—The lowest level of true provider interaction is by way of secure messaging. The question or topic of the engagement is sent to a selected provider (whether online or not) and can be answered by this provider at her leisure. Turnaround times are monitored by the system and are part of the credentials of the provider used for her selection by consumers. The system informs the consumer once a response has been received and can allow the consumer to redirect the question if he needs more urgent response time. For example, typical types of asynchronous correspondence include e-mail, instant messaging, text-messaging, voice mail messaging, VoIP messaging (i.e., leaving a message using VoIP), and paper letters (e.g., via the U.S. Postal Service).

Synchronous correspondence—Several forms of synchronous correspondence allow the consumer and the provider to engage in real-time discussions.

Synchronous text correspondence—This is referred to as a “Chat” module where both sides of the engagement type their entries in response to each others' entries. The form of communication is text based but is still a live communication. Examples include instant messaging and SMS messaging.

Web-based streaming live video—The use of broadband network connections allows for real-time voice and video transmission over the Internet. Web-based teleconferencing uses VoIP, SIP, and other standard or proprietary technologies. Small digital cameras, referred to as webcams, attached to or built in to personal computers or laptops can be used for this purpose and can be provided by standard software or by custom software provided by the brokerage. Alternatively, dedicated video conferencing communication equipment or telephones with built-in video capabilities can be used.

Telephonic conferencing—Consumers who wish for a direct telephonic communication with a provider or who are not comfortable using their computer use a traditional telephone for interaction with a provider. The consumer uses a dial-in number and an access code that connects him to the brokerage's servers. Providers are linked to the servers via VoIP, other data-network-based voice systems, or their own telephones. Telephonic conferencing also allows consumers to request “call me now” functions, in which the provider calls the consumer (directly or through the brokerage).

In some examples, a consumer redirects an active engagement to another provider or provider type. A consumer redirects an engagement to employ a different mode of communication with the current provider (e.g., move from a text chat to a phone conversation).

Service providers are the individuals responding to consumers queries and participating in engagements and streaming live video/audio over the network. Providers agree to the terms of the brokerage, such as payment for their time in performing engagements, the protocol of conduct desired, and the ramification and distribution of liability in case of violations of that protocol.

Prior to joining the brokerage network, a provider establishes a profile that that is searchable by consumers. The profile is used for several purposes, including determining the relative cost of the provider's time to either the consumer or the brokerage sponsor, and providing consumers with information that is relevant to their choice to engage one provider versus another. The provider's profile is used to allow a provider (e.g., a celebrity) to establish a forum in which consumers (e.g., fans) bid for the provider's time. In one particular example, a celebrity wants to auctions a predefined period of time (e.g., ten minutes) in which the celebrity engages in a consultation (e.g., a discussion) with a consumer and sends the proceeds of the consultation to a charity. [

Some information about the provider is verified by the brokerage (e.g., Tax ID, education, professional certification, demographics, and contact information), and some is acquired during the provider's participation on the brokerage. Such data includes length of service, number of engagements, consumer satisfaction, projected availability, etc. A provider also provides a general introductory note, a picture, and voice and video welcome snippets. Providers also add other information they deem relevant for consumers (e.g., a list of publications and honorary appointments). Individual service providers are also able to register and enroll with the system. Individual service providers are independent service providers not affiliated with a provider network. As part of the provider selection process described above, consumers benefit from access to introductory material from the provider. As consumers search for providers to meet their needs, they can select to view only providers where such material is available, producing an incentive for providers to take advantage of such capability.

Providers interact with consumers through a provider console web page. This interface is similar to that used by the consumers. The provider console provides access to the various tools used by providers. A window shows a live image of the consumer, with tools to control or disable the video feed. A phone control allows the provider to initiate a phone call with the consumer. A log of an ongoing chat is displayed above an input for the provider's next comment. Other tools are available in tabs on the side, such as accesses to the terms of operation and the legal policies of the brokerage, such as disclaimers. State setting allows the providers to change his availability state between states such as off-line, on-line and out-of-office. Scheduling allows providers to update their availability calendar with future times they expect to be available on the system, which can in turn result in consumers seeing a “scheduled” state for such providers.

Messaging tools allow providers to correspond with consumers in message-based engagements. The console also allows the provider to participate in chat engagements where the consumer and the provider communicate back-and-forth in real-time by typing. The brokerage allows a single provider to engage in more than one chat at a time to maximize his yield while consumers are typing their entries. The chat feature also allows the provider to forward specific lists of questions to further reduce the need for his time in acquiring information from the consumer at the beginning of an engagement. Tools available to assist the provider in chat or messaging include a thread viewer, the consumer's engagement history, a communication timeline chart, and a library of built-in and self-produced message templates for quick response, and a knowledgebase for sales and support agents (e.g., when the system is used in private operator mode). Such templates also include references, links, and embedded graphical educational content on prevalent topics. In some examples, the brokerage scans outbound messages for inappropriate language based on the sponsor's preferences.

The console allows the provider to hold a voice conference engagement with the consumer when the consumer is using either her computer or a telephone. The provider can use the console to redirect his end of the conference to a phone, for example, if bandwidth or other considerations indicate it or simply based on personal preference. The console also allows the provider to engage in video conferences with consumers. Audio is served via the console or is redirected to a telephone. To verify a provider's identity when using the telephone for a voice engagement, the system provides the provider with a PIN number through the provider console. When the provider calls into the system, or answers the phone when called by the system, the provider enters the PIN to confirm that the person on the phone is the same person who is logged into the console. This method is also used to leave secure voice message. When a provider wants to leave a message for a consumer, the provider requests permission from the console to leave a message and receives a PIN that allows the provider to leave the message. The provider receives a call from the system, enters the PIN, and leaves the message. The message is delivered to the consumer. The use of the PIN provides an assurance that the message was left by the provider.

The provider is able to review his account status, system settings, and preferences. The provider can also access his profile and user satisfaction and statistics as they are available to consumers. The console also connects to financial services associated with the provider's participation in the brokerage. This includes status of charges. The brokerage offers providers the ability to redirect messages or requests for appointment to SMS-compatible cellular phones. In this mode, the provider associates a cell phone number with his account and establishes the type of information that the system can send to the mobile device. Such information includes engagement-related notifications as well as system-related notifications (e.g., an announcement about a high-traffic state asking providers to make themselves available and offering a higher fee to do so).

Referring to FIG. 2, brokerage system 110 generates data for webpage 170 that is rendered on displays of client devices 122. Consumer 120 uses a client device 122 to access a web page that causes a display of webpage 170 from brokerage system. Upon receiving the request the brokerage system 110 identifies a group of service providers that are available to engage in a consultation with consumer 120. Brokerage system 110 causes webpage 170 to be updated with items 172, 174, 176, 178, 180, 184, 186 corresponding to the service providers in the identified group. These items 172, 174, 176, 178, 180, 184, 186 include visual representations of the identified service providers and other information such as the name of the service provider, a star rating of the service provider, and a practice area (or specialty) of the service provider and current availability status.

Webpage 170 also displays controls 172a, 174a, 176a, 178a, 180a, 184a, 186a, selection of which (by consumer 120) causes brokerage system 110 to establish a communication channel between device 122 used by consumer 120 and a device used by a service provider associated with the selected control.

One or more of controls 172a, 174a, 176a, 178a, 180a, 184a, 186a are color coded to indicate communication modes in which service providers are available for consultations. One color indicates that a service provider is only available for telephonic engagements. Another color indicates that a service provider is available for text-based online communications, telephonic communications and video-based communications.

Brokerage system 110 selects providers represented by items 172, 174, 176, 178, 180, 184, 188 independent of a consumer search for service providers. Brokerage system 110 selects these providers based on various criteria, e.g., based on an amount of time a service provider has been available to engage with the consumer. Availability time is information indicative of an amount of time a service provider is available and not otherwise engaged with a consumer. Brokerage system 110 selects service providers with an increased amount of availability time, e.g., relative to amounts of availability time associated with other service providers, to promote decreasing an amount of time in which service providers are idle (e.g., available but not currently engaged in a consultation). Brokerage system 110 selects these providers based on geographic locations in which the service providers are licensed. For example, when client device 122 accesses webpage 170, client device 122 sends to brokerage system 110 a cookie that specifies a geographic location of client device 122. Using the geographic location of client device 122, brokerage system 110 identifies service providers who are available and who are licensed in the geographic location of client device 122.

Upon receiving the request to access the web page, brokerage system 110 also identifies service providers who are not available but who the consumer may be interested in consulting with, e.g., via a scheduled appointment. Brokerage system 110 identifies these unavailable service providers based on a random selection process and/or based on attributes associated with the unavailable service providers.

Brokerage system 110 also identifies these unavailable service providers based on a specialty and/or a provider type associated with these unavailable service providers. For example, brokerage system 110 identifies available service providers that are associated with various specialties. Brokerage system 110 is unable to identify an available service provider associated with a particular specialty (e.g., cardiology). Brokerage system 110 identifies unavailable service providers who are associated with the particular specialty and selects one or more of the unavailable service providers for representation in webpage 170. Brokerage system 110 identifies an unavailable service provider, for representation in webpage 170, who is associated with a decreased amount of wait time (e.g., an amount of time a consumer needs to wait to engage with the service provider), relative to the amount of wait times for other of the identified, unavailable service providers. Brokerage system 110 identifies service providers represented by information 183, 189 as being unavailable but represented in webpage 170. Webpage 170 displays information 183, 189 representing service providers who are unavailable and with whom a consumer can schedule an appointment.

Webpage 170 also displays information 196 to indicate that a service provider is available but not currently available. Information 196 specifies that a service provider is currently engaged with a consumer. Selection of control 180a places an entry for consumer 120 in a queue of consumers who are waiting for consultations with the service provider represented by item 180. When the entry for consumer 120 is first in the queue, brokerage system 110 takes the entry out of the queue and establishes a communication between device 122 used by consumer 120 and a device used by the service provider represented by item 180.

The service providers represented by items 172, 174, 176, 178, 180, 183, 184, 186, 189 are unassociated providers, e.g., providers who are unassociated with a provider practice. For example, items 172, 174, 176 represent service providers associated with provider information 152, 154, 156 (FIG. 1). In a variation of FIG. 2, webpage 170 would display information representing service provider associated with provider practices (not shown) and information representing service providers unassociated with provider practices. Webpage 170 displays information representing service providers associated with provider information 152, 154, 156 and information representing service providers associated with provider information 140, 142, 144 (FIG. 1).

Referring to FIG. 3, webpage 200 displays items 202, 204, 206, 208, 210, 212, 214, 216, 218 representing service providers who are associated with the provider practice represented in portion 201 of webpage 201. Brokerage system 110 generates data for webpage 200 that is rendered by client devices 122. Consumer 120 uses client devices 122 to access, from brokerage system 110, a web page that causes a display of webpage 200 from brokerage system 110. Upon receiving the request to access the web page, brokerage system 110 identifies service providers who are available to engage in a consultation with consumer 120 and who are associated with a particular provider practice specified in portion 220 of web browser 203.

Consumer 120 accesses a webpage that renders webpage 200, e.g., by entering a uniform resource location (URL) address into portion 220 of web browser 203. Following entry of the URL information into web browser 203, client device 122 sends, to brokerage system 110, a request for a web page that is accessible from the specified URL. The request includes the information specified in portion 220 of web browser 203. In response, brokerage system 110 sends to client device 122 data for displaying webpage 120.

Using information specified in portion 220 of web browser 203, brokerage system 110 identifies service providers who are associated with the provider practice specified by the information entered in portion 220 of web browser 203, e.g., by determining a match between the information entered in portion 220 of web browser 203 and practice information (practice information 158, 160). Following determination of the match, brokerage system 110 determines which service providers are associated with the matching provider practice. In an example, brokerage system 110 identifies a match between the information entered in portion 220 of web browser 203 and practice information 158. Based on the match, brokerage system 110 determines that service providers represented by provider information 146, 148, 150 are associated with the request provider practice.

Brokerage system 110 identifies that service providers represented by items 202, 204, 206, 208, 210, 214, 216 are available to engage in a consultation with consumer 120 and are associated with the request provider practice (e.g., the provider practice specified in portion 220). Brokerage system 110 causes webpage 200 to be updated with information 202, 204, 206, 208, 210, 214, 216.

Brokerage system 110 selects providers represented by items 202, 204, 206, 208, 210, 214, 216 independent of a consumer search for service providers and based on the user's request to access the web page associated with the URL specified in portion 220. Brokerage system 110 selects these providers based on various criteria, e.g., based on an amount of time a service provider has been available to engage with the consumer. Availability time is information indicative of an amount of time a service provider is available and not otherwise engaged with a consumer. Brokerage system 110 selects service providers with an increased amount of availability time, e.g., relative to amounts of availability time associated with other service providers, to promote decreasing an amount of time in which service providers are idle (e.g., available but not currently engaged in a consultation). Brokerage system 110 selects these providers based on geographic locations in which the service providers are licensed. For example, when client device 122 sends a request to access a web page that displays webpage 200, client device 122 sends to brokerage system 110 a cookie that specifies a geographic location of client device 122. Using the geographic location of client device 122, brokerage system 110 identifies service providers who are available, who are licensed in the geographic location of client device 122 and who are associated with the requested provider practice.

Upon receiving the request to access the web page that renders webpage 200, brokerage system 110 also identifies service providers who are associated with the request provider practice, who are not available but who the consumer may be interested in consulting with, e.g., via a scheduled appointment. Brokerage system 110 identifies these unavailable service providers based on a random selection process and/or based on attributes associated with the unavailable service providers.

Brokerage system 110 also identifies these unavailable service providers based on a specialty and/or a provider type associated with these unavailable service providers who are associated with the requested provider practice. For example, brokerage system 110 identifies available service providers that are associated with various specialties within the requested provider practice. Brokerage system 110 is unable to identify an available service provider associated with a particular specialty (e.g., cardiology) in the requested provider practice. Brokerage system 110 identifies unavailable service providers who are associated with the particular specialty within the requested provider practice and selects one or more of the unavailable service providers for representation in webpage 200. Brokerage system 110 identifies an unavailable service provider, for representation in webpage 200, who is associated with a decreased amount of wait time (e.g., an amount of time a consumer needs to wait to engage with the service provider), relative to the amount of wait times for other of the identified, unavailable service providers. Brokerage system 110 identifies service providers represented by information 212, 218 for inclusion in webpage 200. Webpage 170 displays information 212, 218 representing service providers who are unavailable, who are associated with the requested provider practice and with whom a consumer can schedule an appointment.

Webpage 170 also displays controls 220, 224, 226, 228, 230, 232, 234 selection of which (by consumer 120) causes brokerage system 110 to establish a communication channel between device 122 used by consumer 120 and a device used by a service provider associated with the selected control.

One or more controls 220, 224, 226, 228, 230, 232, 234 are color coded to indicate communication modes in which service providers are available for consultations. One color indicates that a service provider is only available for telephonic engagements. Another color indicates that a service provider is available for text-based online communications, telephonic communications and video-based communications.

Webpage 200 also displays information 236 to indicate that a service provider is available but not currently available. Information 236 specifies that a service provider is currently engaged with a consumer. Selection of control 230 places an entry for consumer 120 in a queue of consumers who are waiting for consultations with the service provider represented by item 210. When the entry for consumer 120 is first in the queue, brokerage system 110 takes the entry out of the queue and establishes a communication between device 122 used by consumer 120 and a device used by the service provider represented by item 210.

Referring now to FIG. 4, the computerized system 110 tracks 240 the availability of providers 130 that are associated with types of services offered by sponsors and/or that are associated with various provider practices. A provider 130 logs (242) into the system 100. The provider 130 identifies associated provider practices, if any. The provider 130 specifies, via information sent to server 110, whether the provider is associated with one of the provider practices specified in practice information 158, 160. The server 110 uses this information in updating database with new information specifying that the provider 130 is associated with one of practice information 158, 160.

The provider 130 indicates (244) (such as by setting a check box or selecting a menu entry or by responding to a voice prompt) to the tracking module 112 that he or she is available to interact with consumers 120. The provider 130 can also indicate (246) to the tracking module 112 (such as by setting a check box or selecting a menu entry or by responding to a voice prompt) the modes (e.g., telephone, chat, video conference) by which a consumer 120 can be connected to the provider 130. Alternatively, the tracking module 114 determines (248) the capabilities of the terminals 122 and 132 the consumer 120 and the provider 130 use to connect to the system (for example, by using a terminal-based program to analyze the hardware configuration of each terminal). Thus, if a provider 130 connects to the system 100 by a desktop computer and the provider has a video camera connected to that computer, the tracking module 112 determines that the provider 130 can be engaged by text (e.g., chat or instant messenger), voice (e.g., VoIP) or video conference. Similarly, if a provider 130 connects to the system using a handheld device such as a PDA, the tracking module 112 infers (250) that the provider 130 can be engaged by text or voice. The tracking module 112 can also infer a provider's availability and modes of engagement by the provider's previously provided profile information and the terminal device through which the provider connects to the system.

The tracking module 112 transfers (252) information about the availability and the communication capability of the consumers 120 and the providers 130 to the scheduling module 116 using, for example, one or more well-known presence protocols, such as Instant Messaging and Presence Service (IMPS), Session Initiation Protocol (SIP) for Instant Messaging and Presence Leveraging Extensions (SIMPLE), and the Extensible Messaging and Presence Protocol (XMPP).

Referring to FIG. 5, brokerage system 110 implements process 260 in generating a quick connection webpage (e.g., webpages 170, 200). In operation, brokerage system 110 receives (262) a request to access a webpage with connect now portions (e.g., controls 172a, 174a, 176a, 178a, 180a, 184a, 186a in FIG. 2 and controls 220, 224, 226, 228, 230, 232, 234 in FIG. 3). In response to the request, brokerage system 110 identifies (264) available service providers. When the request is for a specific provider practice, brokerage system 110 identifies available service providers who are associated with the provider practice. Brokerage system 110 also identifies (266) communication modes in which the identified available service providers are available for communication.

Brokerage system 110 generates (268) data for the requested webpage that displays representations of identified available service providers and controls specifying the modes in which the service providers are available for communications. Brokerage system 110 transmits (270) data for the generated webpage to client device 122. In response, brokerage system 110 receives (272), from client device 122, a selection of a particular connect now portion of the webpage (e.g., a selection of one of controls 172a, 174a, 176a, 178a, 180a, 184a, 186a in FIG. 2 or one of controls 220, 224, 226, 228, 230, 232, 234 in FIG. 3). In response, brokerage system 110 establishes (274) a communication channel with device 122 used by consumer 120 and a device used by the service provider associated with the selected control.

FIG. 6 is a block diagram of components 500 of the engagement brokerage system. User devices 508 can be any sort of computing device capable of taking input from a user and communicating over a network (not shown) with server 110 and/or with other client devices. For example, user device 508 can be a mobile device, a desktop computer, a laptop, a cell phone, a personal digital assistant (“PDA”), a server, an embedded computing system, a mobile device and so forth. User devices 508 include monitor 510 which render visual representations of interface 506.

Server 110 can be any of a variety of computing devices capable of receiving information, such as a server, a distributed computing system, a desktop computer, a laptop, a cell phone, a rack-mounted server, and so forth. Server 110 may be a single server or a group of servers that are at a same location or at different locations.

Server 110 can receive information from client device user device 508 via interfaces 506, including, e.g., webpages. Interfaces 506 can be any type of interface capable of receiving information over a network, such as an Ethernet interface, a wireless networking interface, a fiber-optic networking interface, a modem, and so forth. Server 110 also includes a processor 502 and memory 504. A bus system (not shown), including, for example, a data bus and a motherboard, can be used to establish and to control data communication between the components of server 110.

Processor 502 may include one or more microprocessors. Generally, processor 502 may include any appropriate processor and/or logic that is capable of receiving and storing data, and of communicating over a network (not shown). Memory 504 can include a hard drive and a random access memory storage device, such as a dynamic random access memory, machine-readable media, or other types of non-transitory machine-readable storage devices.

Components 500 also include storage device 512, which is configured to store information collected through the brokerage system during a service provider's consultation with a consumer.

Embodiments can be implemented in digital electronic circuitry, or in computer hardware, firmware, software, or in combinations thereof. Apparatus of the invention can be implemented in a computer program product tangibly embodied or stored in a machine-readable storage device and/or machine readable media for execution by a programmable processor; and method actions can be performed by a programmable processor executing a program of instructions to perform functions and operations of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

Other embodiments are within the scope and spirit of the described claims. In an example, the brokerage services described herein may be applied to numerous, different types of service providers, including, e.g., medical professionals, physicians, nurses, and so forth. In another example, due to the nature of software, functions described above can be implemented using software, hardware, firmware, hardwiring, or combinations of any of these. Features implementing functions may also be physically located at various positions, including being distributed such that portions of functions are implemented at different physical locations.

What is claimed is:

1. A computer-implemented method comprises:
receiving an indication of a request to access to a webpage that identifies service providers who are available for consultations; identifying, by one or more computers, in response to the request one or more available service providers;
generating, by the one or more computers, a web page that when displayed on a display device, renders:
visual representations corresponding to the identified service providers; and
selectable portions of the visual representations through which the consumer selects a service provider from the identified service providers; and
receiving data indicating the consumer's selection of the service provider; and
establishing a communication channel between a device used by the selected service provider and the device used by the consumer.

2. The computer-implemented method of claim 1, further comprising:
identifying, by the one or more computers, one or more available first service providers that are associated with a first practice; and
identifying, by the one or more computers, one or more available second service providers that are associated with a second practice.

3. The computer-implemented method of claim 2, wherein the webpage renders:
visual representations corresponding to the one or more identified first service providers and the one or more identified second service providers; and
selectable portions through which the consumer selects one of the one or more identified first service providers or one of the one or more identified second service providers.

4. The computer-implemented method of claim 1, wherein receiving the indication of the request from the device used by the consumer of services comprises:
receiving a request from the device used by the consumer of services to consult with a service provider having a service provider profile that satisfies at least some attributes in a set of attributes that define a suitable service provider; and
wherein the method further comprises:
identifying, by the one or more computers, one or more available service providers satisfying at least some of the attributes in the set of attributes.

5. The computer-implemented method of claim 1, further comprising:
identifying, by the one or more computer systems, at least one service provider as being presently available to engage in a consultation with the consumer.

6. The computer-implemented method of claim 1, wherein one or more of the visual representations are juxtaposed to one or more of the selectable portions in the webpage.

7. The computer-implemented method of claim 1, further comprising:
identifying, by the one or more computers, one or more service providers who are presently available for a consultation with the consumer and who are associated with a particular provider practice.

8. The computer-implemented method of claim 1, further comprising:
determining communication modes that are available for the one or more service providers identified;
wherein the selectable portions of the webpage visually indicate one or more of the determined communication modes that are available for the one or more service providers identified.

9. The computer-implemented method of claim 8, further comprising:
determining communication modes that are available for the one or more service providers identified, with the selectable portions of the webpage being color-coded according to the determined communication modes that are available for the one or more service providers identified.

10. One or more machine readable media storing instructions that are executable to by one or more processing devices to perform operations comprising:
receiving an indication of a request to access to a webpage that identifies service providers who are available for consultations; identifying, by one or more computers, in response to the request one or more available service providers;
generating, by the one or more computers, a web page that when displayed on a display device, renders:
visual representations corresponding to the identified service providers; and
selectable portions of the visual representations through which the consumer selects a service provider from the identified service providers; and
receiving data indicating the consumer's selection of the service provider; and
establishing a communication channel between a device used by the selected service provider and the device used by the consumer.

11. The one or more machine readable media of claim 10, wherein the operations further comprise:
identifying one or more available first service providers that are associated with a first practice; and
identifying one or more available second service providers that are associated with a second practice.

12. The one or more machine readable media of claim 11, wherein the webpage renders:
visual representations corresponding to the one or more identified first service providers and the one or more identified second service providers; and
selectable portions through which the consumer selects one of the one or more identified first service providers or one of the one or more identified second service providers.

13. The one or more machine readable media of claim 10, wherein receiving the indication of the request from the device used by the consumer of services comprises:
receiving a request from the device used by the consumer of services to consult with a service provider having a service provider profile that satisfies at least some attributes in a set of attributes that define a suitable service provider; and
wherein the operations further comprise:
identifying one or more available service providers satisfying at least some of the attributes in the set of attributes.

14. The one or more machine readable media of claim 10, wherein the operations further comprise:
identifying at least one service provider as being presently available to engage in a consultation with the consumer.

15. The one or more machine readable media of claim 10, wherein one or more of the visual representations are juxtaposed to one or more of the selectable portions in the webpage.

16. The one or more machine readable media of claim 10, wherein the operations further comprise:
identifying one or more service providers who are presently available for a consultation with the consumer and who are associated with a particular provider practice.

17. A system comprising:
one or more processing devices; and
one or more machine readable media storing instructions that are executable to by one or more processing devices to perform operations comprising:
receiving an indication of a request to access to a webpage that identifies service providers who are available for consultations; identifying, by one or more computers, in response to the request one or more available service providers;
generating, by the one or more computers, a web page that when displayed on a display device, renders:
visual representations corresponding to the identified service providers; and
selectable portions of the visual representations through which the consumer selects a service provider from the identified service providers; and
receiving data indicating the consumer's selection of the service provider; and
establishing a communication channel between a device used by the selected service provider and the device used by the consumer.

18. The system of claim 17, wherein the operations further comprise:
identifying one or more available first service providers that are associated with a first practice; and
identifying one or more available second service providers that are associated with a second practice.

19. The system of claim 17, wherein the webpage renders:
visual representations corresponding to the one or more identified first service providers and the one or more identified second service providers; and
selectable portions through which the consumer selects one of the one or more identified first service providers or one of the one or more identified second service providers.

20. The system of claim 17, wherein receiving the indication of the request from the device used by the consumer of services comprises:
receiving a request from the device used by the consumer of services to consult with a service provider having a service provider profile that satisfies at least some attributes in a set of attributes that define a suitable service provider; and
wherein the operations further comprise:
identifying one or more available service providers satisfying at least some of the attributes in the set of attributes.
